(19) United States
(12) Patent Application Publication
(10) Pub. No.: US 2017/0190355 A1
(43) Pub. Date: Jul. 6, 2017

(54) WHEEL ALIGNMENT MONITORING

(71) Applicant: GM GLOBAL TECHNOLOGY OPERATIONS LLC, Detroit, MI (US)

(72) Inventor: Youssef A. Ghoneim, Rochester, MI (US)

(73) Assignee: GM GLOBAL TECHNOLOGY OPERATIONS LLC, Detroit, MI (US)

(21) Appl. No.: 14/987,259

(22) Filed: Jan. 4, 2016

(51) Int. Cl. B62D 5/04; G01P 3/44; G07C 5/08; B62D 15/02; G07C 5/02

(52) U.S. Cl. CPC B62D 5/0481; B62D 15/021; G07C 5/02; G07C 5/0841; G01P 3/44

(57) ABSTRACT

A multi-wheel vehicle that employs an electric power steering system is described. A method for operating the vehicle includes determining the vehicle is operating in a straight line, and monitoring parameters associated with the electric power steering and associated with vehicle dynamics. A first self-aligning torque parameter is determined based upon the electric power steering parameters, and a second self-aligning torque parameter is determined based upon the vehicle dynamics parameters. Alignment of the wheels is determined based upon the first and second self-aligning torque parameters.

### TECHNICAL FIELD

This disclosure is related to operation and monitoring wheel alignment of a mobile platform.

### BACKGROUND

Wheel alignment on a multi-wheeled mobile platform may be indicated by parameters corresponding to wheel angles, other wheels and a ground surface. Known wheel alignment parameters include toe, camber and caster, among others. Misaligned wheels and tires can add stress to suspension components and tires, leading to irregular and premature tire wear and reduced service life for the suspension components. Toe is an angular measurement of a wheel in relation to a longitudinal axis or an axis of travel of the vehicle. Camber is an angular measurement of a wheel in relation to a vertical axis of the mobile platform.

Known mobile platform systems actively control elements of chassis and suspension systems during operation, including steering, ride stiffness, load management, and others. Known active chassis and suspension systems rely upon accurate wheel alignment for effective operation. Mobile platforms employing active suspension systems may employ sensors, including wheel speed sensors and inertial sensors, such as yaw-rate sensors and accelerometers, to monitor operation.

### SUMMARY

A multi-wheel vehicle that employs an electric power steering system is described. A method for operating the vehicle includes determining the vehicle is operating in a straight line, and monitoring parameters associated with the electric power steering and associated with vehicle dynamics. A first self-aligning torque parameter is determined based upon the electric power steering parameters, and a second self-aligning torque parameter is determined based upon the vehicle dynamics parameters. Alignment of the wheels is determined based upon the first and second self-aligning torque parameters.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 is a plan view schematic diagram of a wheeled vehicle, in accordance with the present disclosure;

FIG. 2 graphically shows a process for evaluating wheel alignment in an embodiment of the vehicle described with reference to FIG. 1, in accordance with the disclosure;

FIG. 3 schematically shows a process for detecting occurrence of vehicle straight-line driving employing an embodiment of the vehicle described with reference to FIG. 1, in accordance with the disclosure;

FIG. 4 schematically shows a process for adjusting a signal from the lateral accelerometer due to bank and crown road effect as indicated by a lateral acceleration state and a lateral acceleration offset, employing an embodiment of the vehicle described with reference to FIG. 1, in accordance with the disclosure;

FIG. 5 schematically shows a first portion of vehicle alignment evaluation routine that includes detecting wheel misalignment and determining a fault class associated with wheel misalignment, in accordance with the disclosure;

FIG. 6 schematically shows a second portion of vehicle alignment evaluation routine that includes determining a severity level associated with detected wheel misalignment, in accordance with the disclosure; and

FIG. 7 schematically shows an embodiment of an off-board evaluation routine for evaluating occurrence of wheel misalignment by type and fault severity in accordance with the disclosure.

### DETAILED DESCRIPTION

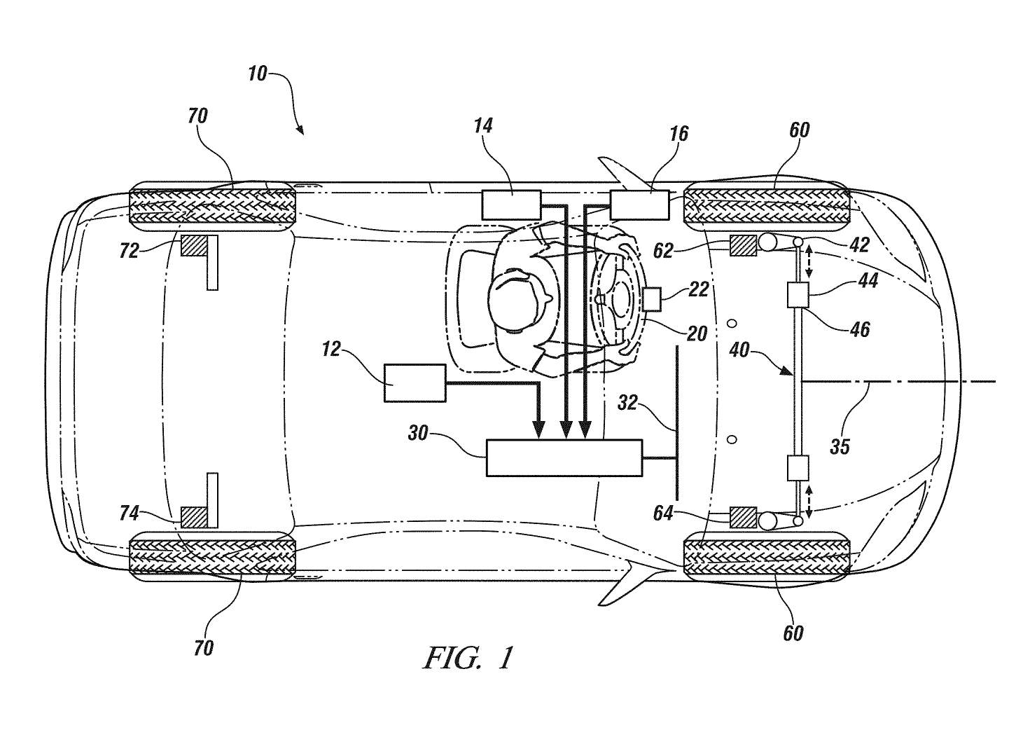

Referring now to the drawings, wherein the depictions are for the purpose of illustrating certain exemplary embodiments only and not for the purpose of limiting the same, FIG. 1 schematically illustrates a mobile platform in the form of a wheeled ground vehicle 10. The vehicle 10 may include any mobile platform, including by way of non-limiting examples, a passenger vehicle, a light-duty or heavy-duty truck, a utility vehicle, an agricultural vehicle, an industrial/warehouse vehicle, a recreational off-road vehicle, a robotic device, or an aeronautic device. The vehicle 10 includes two front wheels 60 and two rear wheels 70 in certain embodiments, and a steering wheel 20 that operatively connects to a power steering system 40. An operator controls direction of travel of the vehicle 10 by controlling the direction of the steerable front wheels 60 through interaction with the steering wheel 20 that controls a power steering system 40. In certain embodiments, the power steering system 40 is an electrically-actuated power steering system. The steering wheel 20 is equipped with a steering wheel angle sensor 22 to monitor operator input in the form of a steering command. Other steering sensors include a pinion angle sensor 42, a power steering torque assistance sensor 44, and a steering torque sensor 46. In certain embodiments, the power steering torque assist sensor 44 may be in the form of a sensor that monitors motor torque of the power steering system 40, wherein the power steering torque assist is determined based upon the motor torque multiplied by a steering gear ratio. In one embodiment, the front wheels 60 are steerable relative to a longitudinal axis 35 of the vehicle 10 to provide steering capability and the rear wheels 70 are fixed relative to the longitudinal axis 35 of the vehicle 10, although the concepts described herein can be applied to a four-wheel steer vehicle and a rear-wheel steer vehicle.

The vehicle 10 is preferably equipped with other sensors, including a vehicle speed sensor 16, a lateral accelerometer 14, and a yaw rate sensor 12. The vehicle 10 is further equipped with left and right front wheel speed sensors 62, 64, respectively, and left and right rear wheel speed sensors 72, 74, respectively. The rotational speed sensors including the wheel speed sensors may be any suitable transducers, e.g., Hall-effect sensors or optical devices. In certain embodiments, the yaw rate sensor 12 is a gyroscopic device that measures a vehicle's angular velocity around its vertical axis, wherein the angle between the vehicle's heading and vehicle actual direction of movement is called slip angle, which is related to the yaw rate. The lateral accelerometer 14 may be any suitable sensing device capable of monitoring lateral acceleration. The aforementioned sensors communicate with a controller 30, either via a direct-wired link or via a communication bus 32.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be executed at regular intervals, for example each 100 milliseconds during ongoing operation. Alternatively, routines may be executed in response to occurrence of a triggering event. Communication between controllers, and communication between controllers, actuators and/or sensors may be accomplished using a direct wired link, a networked communication bus link, a wireless link or any other suitable communication link. Communication includes exchanging data signals in any suitable form, including, for example, electrical signals via a conductive medium, electromagnetic signals via air, optical signals via optical waveguides, and the like. Data signals may include signals representing inputs from sensors, signals representing actuator commands, and communication signals between controllers. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. Data signals may include signals representing inputs from sensors, signals representing actuator commands, and communications signals between controllers. One controller may be configured to execute extra-vehicle communications, such as via telemetry or another mechanism, to communicate with a remote base station.

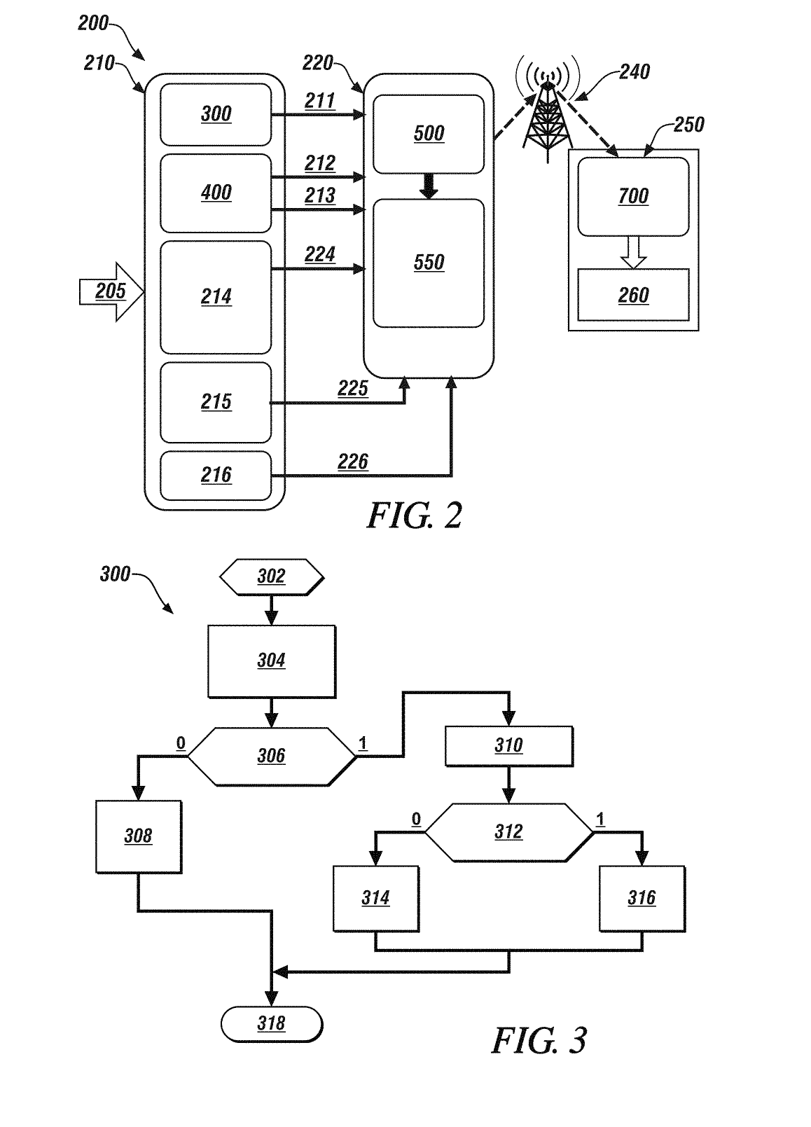

FIG. 2 graphically shows a process 200 for evaluating wheel alignment in an embodiment of the vehicle 10 described with reference to FIG. 1. The process 200 is preferably implemented as a plurality of routines that periodically execute during vehicle operation. The process 200 includes monitoring input signals (205) from sensors on-board the vehicle 10, and determining vehicle operating conditions based upon the input signals (210). Vehicle alignment is evaluated based upon the vehicle operating conditions (220), and occurrence of misalignment, if any, is communicated via a wireless communications system 240 to an off-board facility 250 for further analysis and follow-up, including operator notification if necessary (260). The occurrence of misalignment preferably includes a determination of a misalignment fault class, e.g., toe or camber, and a severity level in certain embodiments.

Monitoring input signals (205) from the vehicle 10 preferably includes monitoring states from the steering wheel angle sensor 22, the pinion angle sensor 42, the power steering torque assistance obtained from the power steering torque assist sensor 44, the steering torque sensor 46, the vehicle speed sensor 16, the lateral accelerometer 14, the yaw rate sensor 12, the left and right front wheel speed sensors 62, 64, respectively, and the left and right rear wheel speed sensors 72, 74, respectively. Other suitable sensors or sensing mechanisms, e.g., executable models based upon other inputs and/or simulations, may be employed.

Determining vehicle operating conditions based upon the input signals (210) preferably includes detecting occurrence of vehicle straight-line driving (300), as indicated by a state of a straight-line flag 211, adjusting a signal from the lateral accelerometer (400), as indicated by a lateral acceleration state 212 and a lateral acceleration offset 213, estimating a first self-aligning torque (SAT_{EPS}) 224 based upon operation of the power steering system (214), estimating a second self-aligning torque (SAT_{VD}) 225 based upon vehicle dynamics (215), and estimating a yaw rate 226 (216).

FIG. 3 schematically shows a process for detecting occurrence of vehicle straight-line driving (300), which may be indicated by a state of the straight-line flag 211, employing an embodiment of the vehicle 10 described herein. Table 1 is provided as a key wherein the numerically labeled blocks and the corresponding functions are set forth as follows, corresponding to the process for detecting occurrence of vehicle straight-line driving (300).

TABLE 1

| BLOCK | BLOCK CONTENTS |
|---|---|
| 302 | Initiate routine |
| 304 | Calculate |
| | ΔV₁₁ = Abs(V_{LF} − V_{RF}) |
| | ΔV₃₄ = Abs(V_{LR} − V_{RR}) |
| | ΔV₁₄ = Abs(V_{LF} − V_{RR}) |
| | ΔV₂₃ = Abs(V_{RF} − V_{LR}) |
| 306 | Is |
| | ΔV₁₁ ≦ ΔVₜₕ₁ & |
| | ΔV₃₄ ≦ ΔVₜₕ₁ & |

| | |
|---|---|
| ΔV₁₄ ≦ ΔVₜₕ₂ & | for > X seconds? |

| | |
|---|---|
| | ΔV₂₃ ≦ ΔVₜₕ₂ & |
| | Vₓ ≧ Vₜₕ |
| 308 | Vehicle not moving in straight line |
| | Set straight line flag = 0 |
| 310 | Calibrate Yaw rate sensor |
| | Calculate Yaw acceleration |
| 312 | Is |
| | Abs(Yaw rate) < Yaw_rate_SL_thr, and |
| | Abs(Yaw accel) < Yaw_acc_SL_thr |
| | for X seconds? |
| 314 | Vehicle not moving in straight line |
| | Set straight line flag = 0 |
| 316 | Vehicle moving in straight line |
| | Set straight line flag = 1 |
| 318 | Communicate straight line flag |

Upon initiating the process for detecting occurrence of vehicle straight-line driving (302), a plurality of differential wheel speeds are calculated (304), including

ΔV₁₁=Abs(V_{LF}−V_{RF})

ΔV₃₄=Abs(V_{LR}−V_{RR})

ΔV₁₄=Abs(V_{LF}−V_{RR})

ΔV₂₃=Abs(V_{RF}−V_{LR}) [1]

wherein:

V_{LF} is the left front wheel speed,

V_{RF} is the right front wheel speed,

V_{LR} is the left rear wheel speed, and

V_{RR} is the right rear wheel speed, as measured by the associated sensors.

The differential wheel speeds represent comparisons of all the left, right, front and rear wheel positions. The differential wheel speeds are compared with threshold differential speeds Vₜₕ₁ and Vₜₕ₂, wherein the threshold differential speeds Vₜₕ₁ and Vₜₕ₂ indicate maximum speed differentials associated with vehicle operation in a straight line, as follows (306):

ΔV₁₁≦ΔVₜₕ₁ &

ΔV₃₄≦Vₜₕ₁ &

ΔV₁₄≦ΔVₜₕ₂ &

ΔV₂₃≦ΔVₜₕ₂ &

Vₓ≧Vₜₕ [2]

The Vₓ term indicates vehicle speed. When one or more of the differential wheel speeds is greater than or equal to the associated threshold speed or the vehicle speed is less than a minimum threshold speed Vth (304)(0), it indicates that the algorithm is unable to reliably determine that the vehicle is travelling in a straight line and the straight-line flag 211 is set to a “0” value (308). This result is communicated with the straight-line flag 211 having a “0” value (318).

When the differential wheel speeds are all less than or equal to the associated threshold speed and the vehicle speed is greater than the minimum threshold speed Vth for a period of time, e.g., X seconds (304)(1), the routine 300 calibrates a zero point for the yaw rate sensor 12 and then calculates yaw acceleration (310). It is appreciated that the routine 300 may calibrate the zero point for the yaw rate sensor 12 during a first iteration of the routine 300, and capture data to calculate the yaw acceleration during subsequent iterations.

The absolute value of the yaw rate and the yaw acceleration are compared to associated threshold values for straight line (SL) operation (312), as follows:

Abs(Yaw rate)<Yaw_rate_SL_thr, and

Abs(Yaw accel)<Yaw_acc_SL_thr. [3]

Referring again to FIG. 2 and with continued reference to FIG. 3, when the yaw rate 216 and yaw acceleration 310 remain less than associated straight line thresholds for a period of time greater than X seconds (312)(1), it indicates that the vehicle is travelling in a straight line and the straight-line flag 211 is set to a “1” value (316). This result is communicated with the straight-line flag 211 having a “1” value (318). If not (312)(0), it indicates that the vehicle is not travelling in a straight line and the straight-line flag 211 is set to a “0” value (314). This result is communicated with the straight-line flag 211 having a “0” value (318).

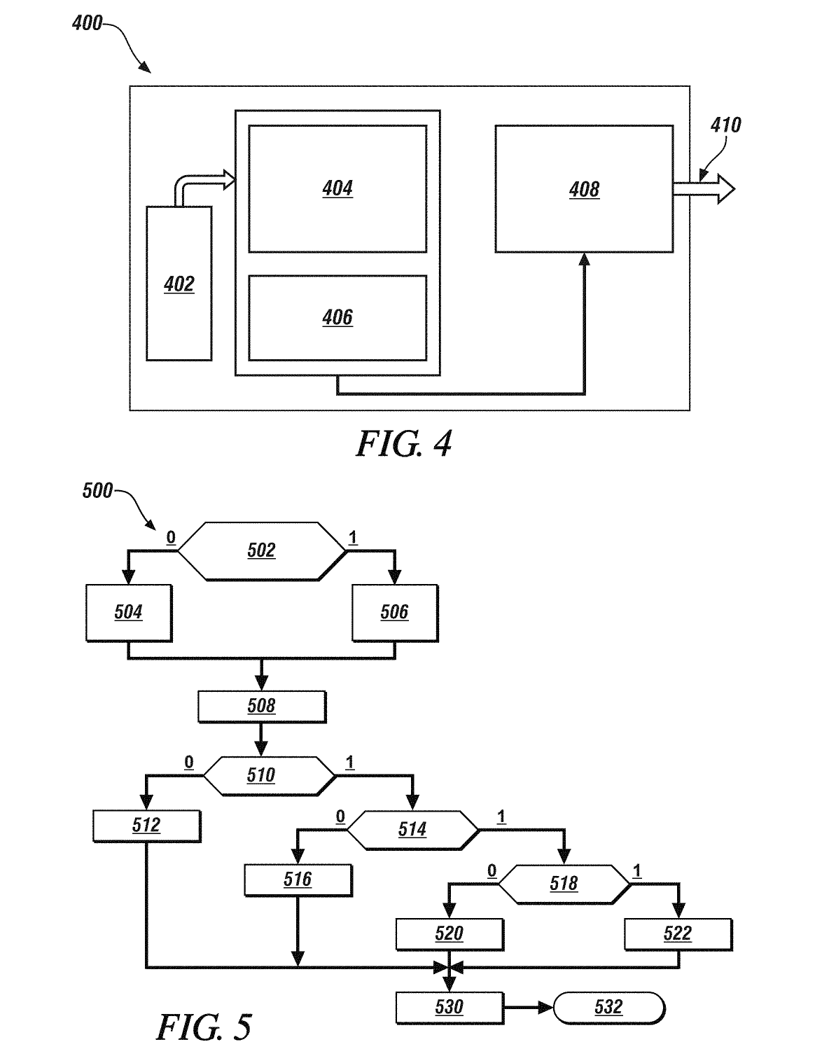

FIG. 4 schematically shows a process for adjusting a signal from the lateral accelerometer due to bank and crown road effect (400), as indicated by a lateral acceleration state 212 and a lateral acceleration offset 213, employing an embodiment of the vehicle 10 described herein. Table 2 is provided as a key wherein the numerically labeled blocks and the corresponding functions are set forth as follows, corresponding to the process for adjusting a signal from the lateral accelerometer (400).

TABLE 2

| BLOCK | BLOCK CONTENTS |
|---|---|
| 402 | Monitor signals from sensors |
| | \dot{ψ} = Yaw rate sensor |
| | a_{ym} = Lateral Accel. sensor |
| | Vₓ = Vehicle Speed |
| 404 | Determine vehicle lateral acceleration |
| 406 | Apply Kalman filter to vehicle lateral |
| | acceleration |
| 408 | Determine adjustment to lateral |
| | accelerometer sensor |
| 410 | Communicate lateral acceleration state and |
| | lateral acceleration offset |

To adjust a signal from the lateral accelerometer due to bank and crown road effect (400), signals from various sensors are monitored (402), as follows:

\dot{ψ}=Signal input from yaw rate sensor

a_{ym}=Signal input from lateral accelerometer

Vₓ=Signal input from vehicle speed sensor

The output from the lateral accelerometer 14 may be expressed as follows:

a_{ym}=a_{y}+g sin φ [4]

wherein:

a_{y} the true lateral acceleration of the vehicle,

a_{ym} is the measured lateral acceleration from the sensor, and

g represents gravitation force.

The true lateral acceleration term a_{y} may be determined from kinematic equations, as follows:

a_{y}=\dot{V}_{y}+\dot{Φ}Vₓ [5]

wherein:

V_{y} represents vehicle speed in the lateral direction,

Vₓ represents vehicle speed in the forward direction, and

φ is the bank angle.

During steady-state operation, \dot{V}_{y}=0, and thus

a_{y}=\dot{φ}Vₓ [6]

A mathematical representation of vehicle lateral acceleration (404) may be defined as follows:

$$x ( t ) = [ \begin{matrix}1 \\ ɛ ( k )\end{matrix} ] \qquad [ 7 ]$$

The term ε(k) is an offset term that can be determined for the lateral acceleration at instant k using a Kalman filter (406), as follows:

$$\begin{matrix}ɛ ( k ) = {a}_{ym} ( k ) - {a}_{y} ( k ) \\ = {a}_{ym} ( k ) - {\dot{ϕ} {V}_{x} ( k )}^{ }\end{matrix} \\ p ( v ) ∼ N ( 0 , Q ) \\ p ( e ) ∼ N ( 0 , R ) \\ R >> Q \qquad [ 8 ]$$

Other related terms include as follows:

y(t)=a_{y}=\dot{φ}Vₓ

H(t)=[a_{ym}(k)−1]

x(t+1)=x(t)+v(t)

y(t)=H(t)*x(t)+e(t).

A lateral acceleration offset term a_{y}_{_}_{offset} 213 is determined as follows:

a_{y}_{_}_{offset}=g sin φ [9]

wherein g is the gravitational force, and

φ is the bank angle or crown angle.

The adjusted lateral acceleration term a_{y}_{_}_{adjusted} 212 can be determined (408) as follows:

a_{y}_{_}_{adjusted}=a_{ym}−a_{y}_{_}_{offset} [10]

The lateral acceleration offset term a_{y}_{_}_{offset} 213 and the adjusted lateral acceleration term a_{y}_{_}_{adjusted} 212 are communicated (410).

Referring again to FIG. 2 and with continued reference to FIG. 4, the lateral acceleration state 212 and the lateral acceleration offset 213 are employed to dynamically evaluate vehicle alignment based upon the vehicle operating conditions (220), as described herein.

The first self-aligning torque may be estimated or otherwise determined based upon operation of the power steering system (SAT_{EPS}) (214) and motor/rack and pinion dynamics using an extended observer model that assumes nominal parameters of the motor/rack parameters. The motor/rack parameters may include the signal inputs from the steering system sensors and actuators, including, by way of non-limiting example the steering wheel angle sensor 22, the pinion angle sensor 42, the power steering torque assistance sensor 44, and the steering torque sensor 46. The first self-aligning torque determined based upon operation of the power steering system (SAT_{EPS}) may be determined as follows:

SAT_{EPS}(k)=Tₜₛ(k)−J_{eq}\hat{f}(\hat{θ}ₚ,\dot{\hat{θ}},w,k)+B_{eq}\dot{\hat{θ}}ₚ+C_{fr}sign(\dot{\hat{θ}}ₚ) [11]

wherein:

Tₜₛ is the signal from the steering wheel torque sensor 46;

J_{eq} is an inertia component, which may be determined in relation to the inertia of the rack and pinion and the EPS motor inertia

\hat{θ}ₚ is a pinion angle;

\dot{\hat{θ}}ₚ is a change in the pinion angle;

w is an external disturbance;

B_{eq} is a damping component, which may be determined in relation to damping of the rack and pinion and the damping coefficient of the EPS motor; and

C_{fr} is the coulomb friction on the steering rack.

The first self-aligning torque based upon operation of the power steering system and motor/rack and pinion dynamics SAT_{EPS} accounts for torque generated by Coulomb friction and viscous friction from the power steering system during vehicle operation. One exemplary process for determining the first self-aligning torque based upon operation of the power steering system SAT_{EPS} and motor/rack and pinion dynamics is described in co-owned U.S. Pat. No. 8,634,986 B2, which is incorporated by reference herein.

The second self-aligning torque based upon vehicle dynamics SAT_{VD} 215 may be may be estimated or otherwise determined as follows:

$$\begin{matrix} {SAT}_{VD} = - {K}_{1} δ - {K}_{2} {a}_{y} - \frac{{K}_{3}}{{v}_{x}} \dot{ψ} & [ 12 ] \\ {K}_{1} = {L}_{p} {C}_{f} \frac{{C}_{r}}{{C}_{f} + {C}_{r}} , & [ 13 ] \\ {K}_{2} = {L}_{p} {C}_{f} \frac{M}{{C}_{f} + {C}_{r}} , and & [ 14 ] \\ {K}_{3} = {L}_{p} {C}_{f} \frac{( a + b ) {C}_{r}}{{C}_{f} + {C}_{r}} & [ 15 ]\end{matrix}$$

wherein:

Lₚ is the pneumatic trail,

C_{f} is the cornering stiffness of both tires of the front axle,

Cᵣ is the cornering stiffness of both tires of the rear axle,

δ is the steering angle,

a_{y} is the lateral acceleration, and

\dot{ψ} is the yaw rate.

The second self-aligning torque based upon vehicle dynamics SAT_{VD} 215 relates to lateral torque generated by forces acting on the vehicle through movement of the tires on the road surface. One exemplary process for determining the second self-aligning torque based upon vehicle dynamics SAT_{VD} is described in co-owned U.S. Pat. No. 8,634,986 B2, which is incorporated by reference herein.

The yaw rate 216 can be estimated in accordance with the following equation:

$${\dot{ψ}}_{est} = \frac{{V}_{x}}{L + {K}_{u} {V}_{x}^{2}} {δ}_{b} = \frac{{V}_{i}}{L + {K}_{u} {V}_{m}^{2}} ( δ - {K}_{u} {a}_{y \_ offset} ) ) \qquad [ 16 ]$$

wherein:

δ_{b}=δ−Kᵤg sin(φ),

δ is the steering angle when the vehicle is driving on a banked surface,

δb is steering angle with the bank effect being compensated,

Ku is the understeer coefficient, and

a_{y}_{_}_{offet}=g sin φ, i.e., the lateral acceleration offset.

Referring again to FIG. 2, the routine 200 evaluates vehicle alignment based upon the vehicle operating conditions (220), including evaluating inputs of the straight-line flag 211, the lateral acceleration state 212, the lateral acceleration offset 213, the SAT_{EPS} 224, the SAT_{VD} 225 and the yaw rate 226. Evaluating the vehicle alignment based upon the vehicle operating conditions (220) initially includes monitoring the straight-line flag 211 and the lateral acceleration offset 213. When the straight-line flag 211 has a value of 1, indicating straight line operation and the lateral acceleration offset 213 is less than a threshold offset for a minimum period of time, alignment evaluation is permissible. Otherwise, the alignment evaluation is postponed.

FIG. 5 schematically shows a first portion of vehicle alignment evaluation routine 500 that includes detecting wheel misalignment and determining a fault class associated with wheel misalignment. Table 3 is provided as a key wherein the numerically labeled blocks and the corresponding functions are set forth as follows, corresponding to the first portion of the vehicle alignment evaluation routine 500.

TABLE 3

| BLOCK | BLOCK CONTENTS |
|---|---|
| 502 | Evaluate alignment parameters |
| 504 | Set detection flag = 0 |
| 506 | Set detection flag = 1 |
| 508 | Determine ΔSAT |
| | ΔSAT = Abs(SAT_{VD}) − Abs(SAT_{EPS}) |
| 510 | Is alignment detection active status = true? |
| 512 | Misalignment status unchanged |
| 514 | Evaluate detection flag and ΔSAT |
| 516 | No Misalignment; set class = 1 |
| 518 | Is ΔSAT < −ΔSATₜₕ? |
| 520 | Toe Misalignment detected; set class = 3 |
| 522 | Camber misalignment detected; set class = 2 |
| 530 | Store fault code |
| 532 | End |

The first portion of the vehicle alignment evaluation routine 500 includes evaluating the alignment parameters (502), including evaluating the adjusted lateral acceleration term a_{y}_{_}_{adjusted} 212, the steering angle δ, the lateral acceleration a_{y}, and the yaw rate \dot{ψ}, and the self-aligning torque based upon vehicle dynamics (SAT_{VD}), as follows:

Abs(a_{y}_{_}_{adjusted})≦a_{y}_{_}ₜₕᵣ &

Abs(\dot{ψ}ₑₛₜ)≦\dot{ψ}ₜₕᵣ &

Abs(SAT_{VD})≦SATₜₕᵣ &

Abs(δ)≦δₜₕ

for x seconds [17]

wherein the respective thresholds a_{y}_{_}ₜₕᵣ, \dot{ψ}, SATₜₕᵣ and δₜₕᵣ are employed to indicate the vehicle is operating in a regime where the detection of the wheel alignment status can be evaluated.

When one or more of the alignment parameters exceeds the corresponding threshold (502)(0), the alignment detection flag is set as false (=0) (504). When all of the alignment parameters are less than the corresponding threshold (502)(1), the alignment detection flag is set as true (=1) (506). In either instance, a self-aligning torque differential ΔSAT is determined as ΔSAT=Abs(SAT_{VD})−Abs(SAT_{EPS}) (508) and the alignment detection active status flag is evaluated (510).

When the alignment detection active status flag is set as false (=0) (510)(0), the misalignment status is determined to be unchanged from a previous iteration (512), and the previous fault code, if any, is stored (530), and this iteration ends (532). When the alignment detection active status flag is set as true (=1) (510)(1), the self-aligning torque differential ΔSAT is evaluated, as compared to a positive threshold +ΔSAT_{thd} and a negative threshold −ΔSAT_{thd} (514). When the self-aligning torque differential ΔSAT is between the positive threshold +ΔSAT_{thd} and the negative threshold −ΔSAT_{thd} (514)(0), no misalignment is detected, and a fault class is set equal to 1. The fault class of 1 is stored (530), and this iteration ends (532). When the self-aligning torque differential ΔSAT is greater than the positive threshold +ΔSAT_{thd} (514)(1), (518)(0), a toe misalignment is detected (520). A fault class of 3 indicating toe misalignment is set and stored (530), and this iteration ends (532). When the self-aligning torque differential ΔSAT is less than the negative threshold −ΔSAT_{thd}, (514)(1), (518)(1), a camber misalignment is detected (522). A fault class of 2 indicating camber misalignment is set and is stored (530), and this iteration ends (532). In this manner, occurrence of misalignment, if any, may be detected and an associated fault class is assigned.

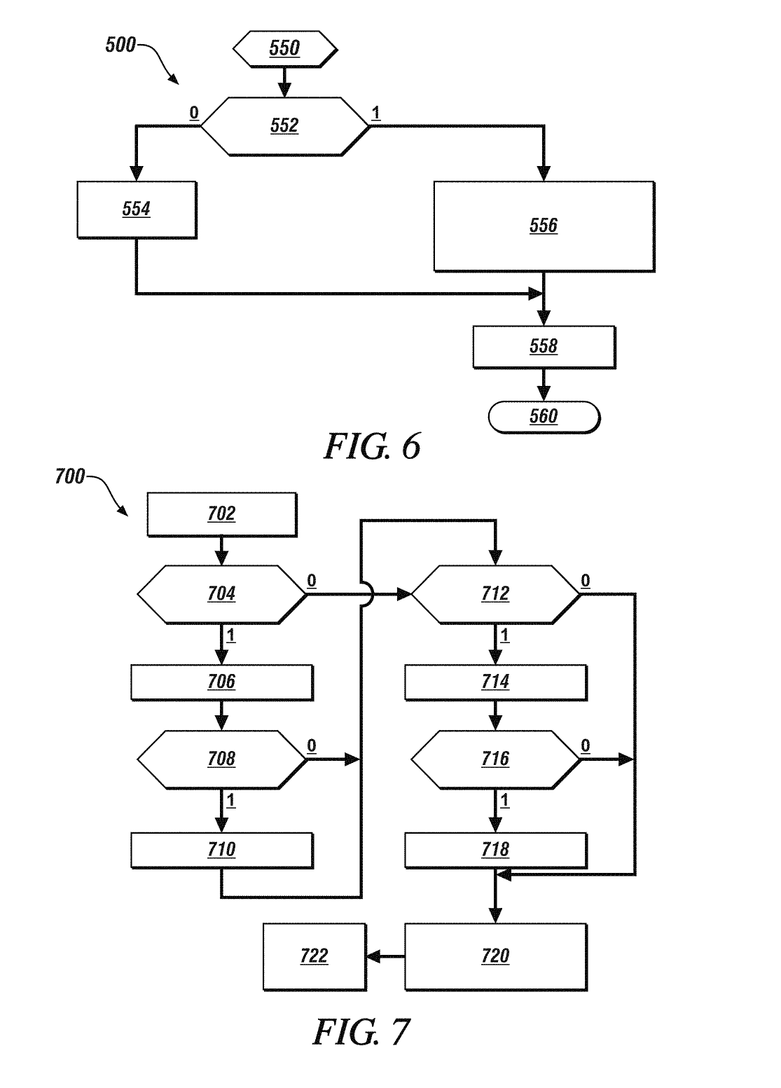

FIG. 6 schematically shows a second portion of vehicle alignment evaluation routine 550 that includes determining a severity level associated with detected wheel misalignment. Table 4 is provided as a key wherein the numerically labeled blocks and the corresponding functions are set forth as follows.

TABLE 4

| BLOCK | BLOCK CONTENTS |
|---|---|
| 550 | Initiate execution |
| 552 | Is alignment detection active status true? |
| 554 | Set severity level = previous severity level |
| 556 | Determine severity level |
| 558 | Store severity level |
| 560 | End |

The second portion of the vehicle alignment evaluation routine 550 to determine a severity level associated with detected wheel misalignment includes as follows. When the alignment detection active status flag is false (552)(0), the severity level is a carryover severity level, and is set equal its previous setting (554). When the alignment detection active status flag is true (552)(1), the severity level is determined as follows (556):

$$Severity = round ( \sqrt{\frac{\begin{matrix}{( \frac{{a}_{y \_ adjusted}}{{a}_{y \_ thr}} )}^{2} + {( \frac{{\dot{ψ}}_{est}}{{\dot{ψ}}_{thr}} )}^{2} + \\ {( \frac{ Abs ( {SAT}_{VD} ) - Abs ( {SAT}_{EPS} )}{Δ {SAT}_{thr}} )}^{2} + {( \frac{δ}{{δ}_{thr}} )}^{2}\end{matrix}}{4}} ) \qquad [ 18 ]$$

The severity level, whether newly determined or carried over, is determined and stored in a non-volatile memory device for future use (558), and this iteration ends (560).

Referring again to FIG. 2, information related to vehicle alignment that is determined based upon the vehicle operating conditions (220) and the misalignment fault class and the severity level, if any, is communicated via the wireless communications system 250 to an off-board facility for further analysis by execution of an off-board evaluation routine 700 and follow-up including operator notification if necessary (260). In certain embodiments, this information is determined once per vehicle trip and communicated to the off-board facility for evaluation.

FIG. 7 schematically shows an embodiment of the off-board evaluation routine 700 for evaluating occurrence of wheel misalignment by type and fault severity. Table 5 is provided as a key wherein the numerically labeled blocks and the corresponding functions are set forth as follows.

TABLE 5

| BLOCK | BLOCK CONTENTS |
|---|---|
| 702 | Initialize: Camber fault severity indicates no |
| | misalignment and toe fault severity |
| | indicates no misalignment |
| 704 | Has a class 2 fault been detected within X |
| | days? |
| 706 | Set camber misalignment fault severity to |
| | “slight” |
| 708 | Have z quantity of class 2 faults been |
| | detected within X days? AND has severity |
| | been greater than severity threshold? |
| 710 | Set camber misalignment fault severity to |
| | “severe” |
| 712 | Has a class 3 fault been detected within X |
| | days? |
| 714 | Set toe misalignment fault severity to |
| | “slight” |
| 716 | Have z quantity of class 3 faults been |
| | detected within X days? AND has severity |
| | been greater than severity threshold? |
| 718 | Set toe misalignment fault severity to |
| | “severe” |
| 720 | Communicate occurrence of “severe” fault |
| | to vehicle |
| 722 | Validate evaluations indicating toe |
| | misalignment and camber misalignment |
| | over multiple vehicle trips and end iteration |

The occurrence of misalignment preferably includes a determination of a fault class and a severity level, as described with reference to FIGS. 5 and 6. Upon initial execution of the off-board evaluation routine (routine) 700, parameters related to camber fault severity indicate no misalignment and parameters related to toe fault severity indicate no misalignment (702). The routine 700 evaluates whether at least one class 2 fault has been detected within X days (704), and if so, (704)(1), sets a camber misalignment fault severity to “slight” (706). The numerical quantities of X days and z faults are calibratable values that may be selected for a specific embodiment to avoid false-positive and false-negative errors and their related issues.

The routine 700 evaluates whether a quantity of “z” class 2 faults have been detected within X days and if the severity level is greater than a minimum threshold severity (708), and if so, (708)(1), sets the camber misalignment fault severity to “severe” (710). The routine 700 evaluates whether at least one class 3 fault has been detected within X days (712), and if so, (712)(1), sets a toe misalignment fault severity to “slight” (714). The routine 700 evaluates whether a quantity of “z” class 3 faults have been detected within X days and if the severity level is greater than a minimum threshold severity (716), and if so, (716)(1), sets the toe misalignment fault severity to “severe” (718). When any of the evaluations have yielded an absence of the associated faults (704)(0), (708)(0), (712)(0) and (716)(0), the routine 700 advances to the next logical step.

When any of the evaluations indicate either that the toe misalignment is “severe” or the camber misalignment fault severity is “severe”, the routine 700 may communicate a request for wheel alignment and the evaluation to the vehicle operator. Likewise, when any of the evaluations indicate either that the toe misalignment is “slight” or the camber misalignment fault severity is “slight”, the off-board evaluation routine 700 may continue monitoring without immediate action, i.e., without communicating a request for wheel alignment to the vehicle operator (720).

The routine 700 periodically validates the evaluations indicating toe misalignment and camber misalignment over a period that includes multiple vehicle trips, and updates the evaluations indicating toe misalignment and camber misalignment based thereon (722). Such updating preferably includes maintaining and updating the decisions related to either the toe misalignment fault severity or the camber misalignment fault severity so long as the corresponding severity is equal to or greater than the previously determined fault severity. Such operation provides an extended time basis for the evaluations. This iteration then ends. As such, a system to determine wheel misalignment and isolate the source during vehicle operation may be reduced to practice as one or more algorithms and control routines.

The flowcharts and block diagrams in the flow diagrams illustrate the architecture, functionality, and operation of possible implementations of systems, methods, and computer program products according to various embodiments of the present disclosure. In this regard, each block in each flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for monitoring operation of a multi-wheel vehicle employing an electric power steering system, the method comprising:
determining the vehicle is operating in a straight line;
monitoring parameters associated with the electric power steering;
monitoring parameters associated with vehicle dynamics;
determining a first self-aligning torque parameter based upon the vehicle dynamics parameters;
determining a second self-aligning torque parameter based upon the electric power steering parameters; and
evaluating alignment of the wheels based upon the first and second self-aligning torque parameters.

2. The method of claim 1, wherein evaluating alignment of the wheels based upon the first and second self-aligning torque parameters comprises determining an arithmetic difference between the first self-aligning torque parameter and the second self-aligning torque parameter.

3. The method of claim 1, wherein evaluating alignment of the wheels based upon the first and second self-aligning torque parameters comprises detecting a fault associated with toe when an arithmetic difference between the first self-aligning torque parameter and the second self-aligning torque parameter is greater than a first threshold.

4. The method of claim 1, wherein evaluating alignment of the wheels based upon the first and second self-aligning torque parameters comprises detecting a fault associated with camber when an arithmetic difference between the first self-aligning torque parameter and the second self-aligning torque parameter is less than a second threshold.

5. The method of claim 1, further comprising communicating the first self-aligning torque parameter and the second self-aligning torque parameter to an off-vehicle processor, wherein the off-vehicle processor evaluates the alignment of the wheels based upon the first and second self-aligning torque parameters.

6. The method of claim 1, further comprising determining a severity level associated with a detected wheel misalignment based upon the first and second self-aligning torque parameters.

7. The method of claim 1, wherein monitoring parameters associated with vehicle dynamics comprises monitoring lateral acceleration, yaw rate, and vehicle speed.

8. The method of claim 1, wherein monitoring parameters associated with the electric power steering comprises monitoring a steering wheel angle, a pinion angle, a motor torque associated with the electric power steering system and a steering torque.

9. The method of claim 1, further comprising
monitoring wheel speeds;
determining whether the vehicle is operating in a straight line based upon the wheel speeds; and
evaluating the alignment of the wheels based upon the first and second self-aligning torque parameters only when the vehicle is operating in the straight line.

10. A multi-wheel vehicle, comprising:
a steering wheel operatively connected to an electric power steering system coupled to steerable wheels;
a steering wheel angle sensor, a pinion angle sensor, a motor torque sensor disposed to monitor the electric power steering system, a steering torque sensor disposed to monitor the steering wheel, a vehicle speed sensor, a lateral accelerometer, yaw rate sensor, left and right front wheel speed sensors, and left and right rear wheel speed sensors;
a controller including a processor and an instruction set executable to monitor the steering wheel angle sensor, pinion angle sensor, motor torque sensor, steering torque sensor, vehicle speed sensor, lateral accelerometer, yaw rate sensor, left and right front wheel speed sensors, and left and right rear wheel speed sensors,
wherein the controller executes instruction sets to:
determine the vehicle is operating in a straight line based upon inputs from the left and right front wheel speed sensors and the left and right rear wheel speed sensors,
determine electric power steering parameters based upon inputs from the steering wheel angle sensor, the pinion angle sensor, the motor torque sensor and the steering torque sensor,
determine vehicle dynamics parameters based upon inputs from the vehicle speed sensor, the lateral accelerometer and the yaw rate sensor,
determine a first self-aligning torque parameter based upon the vehicle dynamics parameters,
determine a second self-aligning torque parameter based upon the electric power steering parameters, and
evaluate alignment of the wheels based upon the first and second self-aligning torque parameters.

11. The multi-wheel vehicle of claim 10, further comprising:
left and right front wheel speed sensors, and left and right rear wheel speed sensors; and
the controller including a processor and an instruction set executable to monitor the left and right front wheel speed sensors, and the left and right rear wheel speed sensors;
wherein the controller executes instruction sets to:
determine whether the vehicle is operating in a straight line based upon inputs from the left and right front wheel speed sensors and the left and right rear wheel speed sensors, and
evaluate the alignment of the wheels based upon the first and second self-aligning torque parameters only when the vehicle is operating in the straight line.

12. The multi-wheel vehicle of claim 10, further comprising:
wherein the controller executes instruction sets to:
adjust the monitored input from the lateral accelerometer due to bank and crown road effect, and
determine vehicle dynamics parameters based upon the input from the vehicle speed sensor, the adjusted input from the lateral accelerometer and the input from the yaw rate sensor.

12. The multi-wheel vehicle of claim 10, further comprising the controller executes instruction sets to detect a fault associated with toe when an arithmetic difference between the first self-aligning torque parameter and the second self-aligning torque parameter is greater than a first threshold.

13. The multi-wheel vehicle of claim 10, further comprising the controller executes instruction sets to detect fault associated with camber when an arithmetic difference between the first self-aligning torque parameter and the second self-aligning torque parameter is less than a second threshold.

14. The multi-wheel vehicle of claim 10, further comprising the controller executes instruction sets to determine a severity level associated with a detected wheel misalignment based upon the first and second self-aligning torque parameters.
